(19) United States
(12) Patent Application Publication
(10) Pub. No.: US 2002/0010778 A1
(43) Pub. Date: Jan. 24, 2002

(54) Server and network system and received load control method thereof

(76) Inventor: Yoshihisa Harada, Tokyo (JP)

Correspondence Address: McGinn & Gibb, PLLC, 8321 Old Courthouse Road, Suite 200, Vienna, VA, 22182-3817, US

(21) Appl. No.: 09/748,849

(22) Filed: Dec. 28, 2000

(30) Foreign Application Priority Data
Jan. 13, 2000 (JP) 009954/2000

(51) Int. Cl. G06F 15/173

(52) U.S. Cl. 709/226

(57) ABSTRACT

A server, a network system, and a received load control method at the network system, in which a received load at the server is reduced and deteriorating processing performance of the server is prevented, are provided. The server provides a shaper, a shaper value setting section, and a processing unit with storage. The shaper compares the total received load caused by received data transferred from plural clients and a shaper value set by the shaper value setting section. And the shaper discards a part of the received data being exceeded the shaper value based on the compared result. Therefore, at an input port of the server, being the shaper, the received load can be control corresponding to a receiving capacity of the server. With this, deteriorating remarkably the performance of the server itself and stopping the functions of the server are prevented. Further, the bad influence for the network caused by the a heavy load can be reduced.

### BACKGROUND OF THE INVENTION

The present invention relates to a server and a network system and a received load control method thereof, in particular, a server executing data communication with plural clients, and a network system including the server, the plural clients, and a network, and a control method of loads received at the server transferred from the plural clients.

### DESCRIPTION OF THE RELATED ART

At a network system in which data communication is executed between a server and plural clients via a network, that is, at a server/client system, when data are transferred to the server from the plural clients at the same time, a heavy received load is applied to the server. At this time, in case that the received load exceeds the receiving capacity of the server, a part of the received data is needed to discard, and this discarding process is a heavy burden for the server.

In case that the server executes discarding the received data continuously due to the heavy load of the received data, the performance of the server is remarkably deteriorated. Consequently, the service for users using the clients is lowered and there is a case that operation of the server is stopped.

In order to avoid or prevent these troubles, it is necessary for the server to avoid the situation that the received load exceeds the receiving capacity of the server.

For example, as a first method, the network system controls so that the received load does not exceed the receiving capacity of the server.

At this first method in which the load of the receiving data is controlled, at the stage of designing the network (server/client) system, the number of clients connecting to the sever is limited, or a memory temporarily storing communication data from the network to the server is provided. With this, the peak value of the received load at the server is made to small. This method has been realized.

As a second method, the receiving capacity of the server is increased so that the receiving capacity of the server is not made to be below the maximum received load supposed at the network.

This second method increasing the receiving capacity of the server is realized by that a high capacity server is adopted, or plural servers are provided so that the received data loaded to one server are distributed to the plural servers.

Japanese Patent Application Laid-Open No. HEI 11-122260 discloses a communication control apparatus and a method thereof. In this application, when the amount of communication data is exceeded a designated threshold value, transferring data itself is stopped and transferred data are discarded.

And Japanese Patent Application Laid-Open No. HEI 11-150544 discloses a function testing method of an asynchronous transfer mode (ATM) apparatus. In this application, inputted cells (data) exceeded a cell buffer threshold value are discarded.

However, the methods mentioned above have been mainly realized by their system structures.

And actually, the network system has been designed by using a server having a lower receiving capacity than the theoretically calculated maximum receiving load because of following reasons.

First, a possibility, which all clients on a network communicate with a server at the same time, is low. And second, a storage device being capable of storing a large amount of data in the network is very expensive. Third, a server being capable of executing high speed operation is also expensive. And fourth, providing plural servers consumes high cost.

At the network system, communication between a server and plural clients is executed without any problem at normal operation. However, when many clients communicate with a server at the same time, there is a possibility that received load in the network exceeds the receiving capacity of the server. And the server has a main function in the server/client network system, therefore when the function of the server is lowered or stopped, there is a problem that the trouble of the server causes big damage to the network system.

### SUMMARY OF THE INVENTION

It is therefore an object of the present invention to provide a server and a network system, in which a receiving load at the server is reduced and also deteriorating the throughput of the server is prevented, and to provide a received load control method at the network system.

According to a first aspect of the present invention, there is provided a server, which provides a comparing means for comparing the amount of received load caused by received data transferred from plural clients with a designated value, and a judging means for judging whether a part of the received data is discarded or not. And the server controls the received load caused by the received data transferred from the plural clients by the judged result.

According to a second aspect of the present invention, in the first aspect, the designated value is set based on a receiving capacity of the server.

According to a third aspect of the present invention, there is provided a server, which provides a shaper value setting means for setting a shaper value based on a receiving capacity of the server, and a shaper means for comparing the amount of received load caused by received data transferred from plural clients and the shaper value, and judging whether a part of the received data transferred from the plural clients is discarded or not.

According to a fourth aspect of the present invention, in the third aspect, the shaper means discards a part of the received data being exceeded the received load by the judged result.

According to a fifth aspect of the present invention, in the fourth aspect, in case that the shaper judges that the amount of the received load exceeds the shaper value and discards a part of the received data, when a part of the received data (packet) is discarded by utilizing an EPD (early packet discard), a remaining part of the packet is discarded early.

According to a sixth aspect of the present invention, in the fourth aspect, in case that the shaper judges that the amount of the received load exceeds the shaper value and discards a part of the received data, a part of the received data (packet) is discarded from a packet having low priority by utilizing a QoS (quality of service) based on the order of priority to each of the received data (packet).

According to a seventh aspect of the present invention, there is provided a network system, which provides plural clients connecting to a network, and a server connecting to the plural clients through the network, wherein. And the server controls the amount of received load caused by the received data transferred from the plural clients.

According to an eighth aspect of the present invention, in the seventh aspect, the server compares the amount of the received load caused by the received data with a designated value and judges whether a part of the received data is discarded or not based on the judged result.

According to a ninth aspect of the present invention, in the eighth aspect, the designated value is set by a receiving capacity of the server.

According to a tenth aspect of the present invention, there is provided a network system, which provides plural clients connecting to a network, and a server connecting to the plural clients through the network. And the server provides a shaper value setting means for setting a shaper value based on a receiving capacity of the server, and a shaper means for comparing the amount of received load caused by received data transferred from plural clients and the shaper value, and judging whether a part of the received data transferred from the plural clients is discarded or not.

According to an eleventh aspect of the present invention, in the tenth aspect, the shaper discards a part of the received data when the amount of the received load exceeds the shaper value.

According to a twelfth aspect of the present invention, in the tenth aspect, in case that the shaper judges that the amount of the received load exceeds the shaper value and discards a part of the received data, when a part of the received data (packet) is discarded by utilizing an EPD, a remaining part of the packet is discarded early.

According to a thirteenth aspect of the present invention, in the tenth aspect, in case that the shaper judges that the amount of the received load exceeds the shaper value and discards a part of the received data, a part of the received data (packet) is discarded from a packet having low priority by utilizing a QoS based on the order of priority to each of the received data (packet).

According to a fourteenth aspect, there is provided a received load control method at a network system in which a server connects to plural clients through a network. And the server provides the steps of; setting a shaper value based on a receiving capacity of the server, comparing the amount of received load caused by received data transferred from the plural clients and the shaper value, and discarding a part of the received data being exceeded the shaper value when the amount of the received load exceeds the shaper value.

According to a fifteenth aspect of the present invention, in the fourteenth aspect, at the discarding a part of the receiving data, in case that the amount of the received load exceeds the shaper value and a part of the received data is discarded, when a part of the received data (packet) is discarded by utilizing an EPD, a remaining part of the received data (packet) is discarded early.

According to a sixteenth aspect of the present invention, in the fourteenth aspect, at the discarding a part of the receiving data, in case that the amount of the received load exceeds the shaper value and a part of the received data is discarded, a part of the received data (packet) is discarded from a packet having low priority by utilizing a QoS based on the order of priority to each of the received data (packet).

According to a seventeenth aspect of the present invention, in the fourteenth aspect, at the setting a shaper value, the shaper value is set by equipment disposed at the outside.

According to the present invention, in order to limit the received load to the designated value, the server monitors the amount of the received data transferred from the plural clients at the input port of the server. When the received load exceeds the designated value, a part of the received data being exceeded the designated value is discarded.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a system structure of a network system of an embodiment of the present invention;

FIG. 2 is a block diagram showing a system structure including a detailed structure of a server shown in FIG. 1 at the network system of the embodiment of the present invention; and

FIG. 3 is a flowchart showing received data control operation at the server in the embodiment of the present invention.

### DESCRIPTION OF THE PREFERRED EMBODIMENT

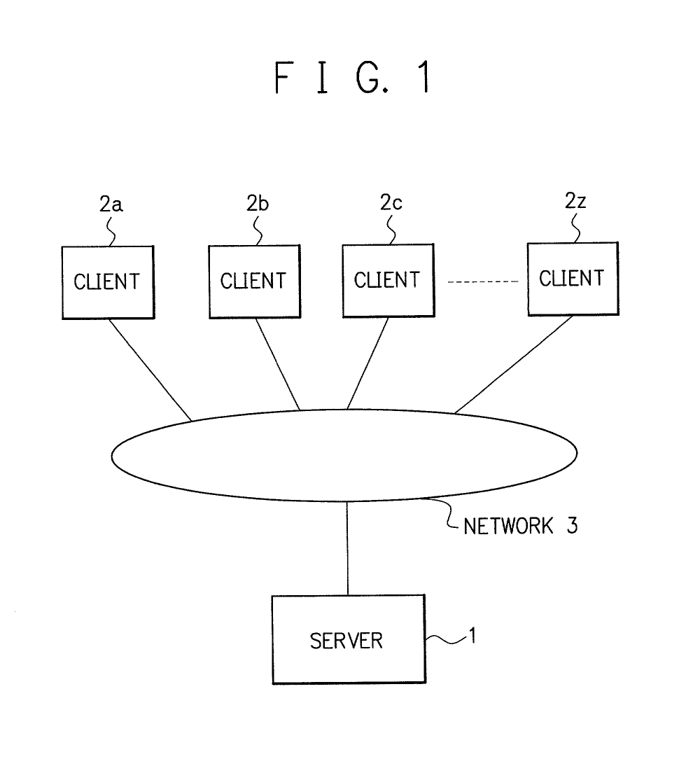

Referring now to the drawings, an embodiment of the present invention is explained in detail. FIG. 1 is a block diagram showing a system structure of a network system of the embodiment of the present invention. As shown in FIG. 1, the network system of the embodiment of the present invention consists of a server 1, plural clients 2a to 2z, and a network 3. And the server 1 and the plural clients 2a to 2z are connected through the network 3, in a state that the server 1 and the plural clients 2a to 2z can communicate with one another.

The server 1 is a server that gives service to the plural clients 2a to 2z by corresponding to request from the plural clients 2a to 2z. And the plural clients 2a to 2z request service for the server 1. The network 3 is a data communication network in which data communication is executed between the server 1 and the plural clients 2a to 2z. For example, the network is a network such as a WAN (wide area network), and a LAN (local area network).

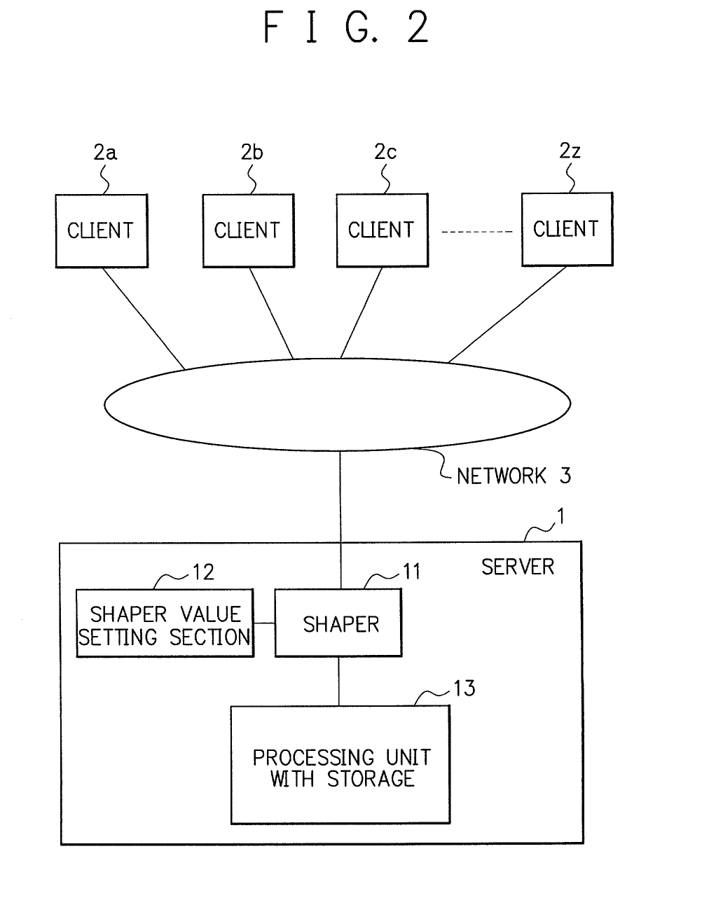

FIG. 2 is a block diagram showing a system structure including a detailed structure of the server 1 shown in FIG. 1 at the network system of the embodiment of the present invention. As shown in FIG. 2, the server 1 consists of a shaper 11, a shaper value setting section 12, and a processing unit with storage 13.

When communication data are transferred from the plural clients 2a to 2z to the server 1 through the network 2, the shaper 11 monitors the amount of received data at the input port of the server 1. In case that the received load caused by the received data exceeds a designated value, the exceeded part of the received data is discarded at the shaper 11 being the input port of the server 1. That is, the load receiving at the server 1 is limited to the designated value at the input port being the shaper 11. Actually, the total amount of the received data is compared with a shaper value set at the shaper value setting section 12, and a part of the received data being exceeded the shaper value is discarded based on the compared result.

In order that the shaper 11 limits the load of the receiving data to be less than a designated value, the shaper value setting section 12 sets the designated value corresponding to a receiving capacity at the processing unit with storage 13. Actually, the shaper value setting section 12 sets the shaper value being a threshold value based on the receiving capacity of the processing unit with storage 13. In this, a user can set this shaper value to the shaper value setting section 12 by using a console (not shown) provided at the outside.

The processing unit with storage 13 executes a receiving process for the remaining data that the received data being exceeded the shaper value are discarded from the total received data.

Next, referring to FIG. 2, the embodiment of the server and the network system and a received load control method of the present invention is explained in more detail.

The plural clients 2a to 2z transfer and receive data to/from the server 1 through the network 3. Each of the plural clients 2a to 2z communicates with the server 1 individually. Consequently, the total amount of communication data between the server 1 and the plural clients 2a to 2z change depending on the communication state of each of the plural clients 2a to 2z.

For example, when each of the plural clients 2a to 2z communicates with the server 1 at the same time, the amount of the communication load at the server 1 becomes its maximum. Especially, when each of the plural clients 2a to 2z transfers a large amount of data at the same time, the received load at the server 1 continues the maximum state.

For example, in case that the receiving capacity of the processing unit with storage 13 in the server 1 is defined to be the same that the amount of communication data that 20 clients 2a to 2t transfer data to the server 1 at the same time. Under this condition, when more than 20 clients transfer data to the server 1 at the same time, the received data load at the server 1 exceeds the receiving capacity of the processing unit with storage 13 in the server 1. Consequently, a part of the received data has to be discarded at the processing unit with storage 13. When a part of the received data is discarded at the processing unit with storage 13, this may cause to deteriorate the performance remarkably and to stop the operation at the processing unit with storage 13.

In order to avoid this, the shaper 11 limits the received data load to a designated value so that the received data load exceeding the data receiving capacity of the processing unit with storage 13 is not applied to the processing unit with storage 13. This designated value is set corresponding to the data receiving capacity of the processing unit with storage 13. In case that the receiving data load for each of the plural clients 2a to 2z is 1 M bps and the data receiving capacity of the processing unit with storage 13 is 20 M bps, for example, the shaper value setting section 12 sets the shaper value as 18 M bps with a margin. In this case, the shaper 11 operates to make the receiving data load limit within 18 M bps.

As a first example, when 10 clients 2a to 2j transfer data to the server 1 at the same time, the receiving data load being 10 M bps is applied to the server 1 at the maximum. In this case, the receiving data load is 10 M bps at the maximum, therefore the shaper 11 does not limit the received data load, and this 10 M bps load is applied to the processing unit with storage 13. This receiving data load 10 M bps is smaller than the receiving capacity 20 M bps of the processing unit with storage 13, therefore receiving operation is executed without any trouble, and the communication data are not discarded at the processing unit with storage 13.

As a second example, when 23 clients 2a to 2w transfer data to the server 1 at the same time, the received data load being 23 M bps is applied to the server 1 at the maximum. In case that the received data load is 23 M bps, the shaper 11 limits the received data load, and discards the received data being 5 M bps=23 M bps−18 M bps. Consequently, the received data load being 18 M bps is applied to the processing unit with storage 13 in the server 1. This received data load 18 M bps is smaller than the receiving capacity 20 M bps of the processing unit with storage 13, therefore receiving operation is executed without any trouble, and discarding data does not occur at the processing unit with storage 13.

In this second example, the processing unit with storage 13 has the margin 2 M bps=20 M bps−18 M bps in the receiving capacity. The processing unit with storage 13 executes detecting abnormal state, displaying the abnormal state, and recovering processes by using this margin, caused by that the shaper 11 discards the exceeded received data. Therefore, remarkable deterioration of the performance and occurrence of stopping the operation can be restrained at the processing unit with storage 13.

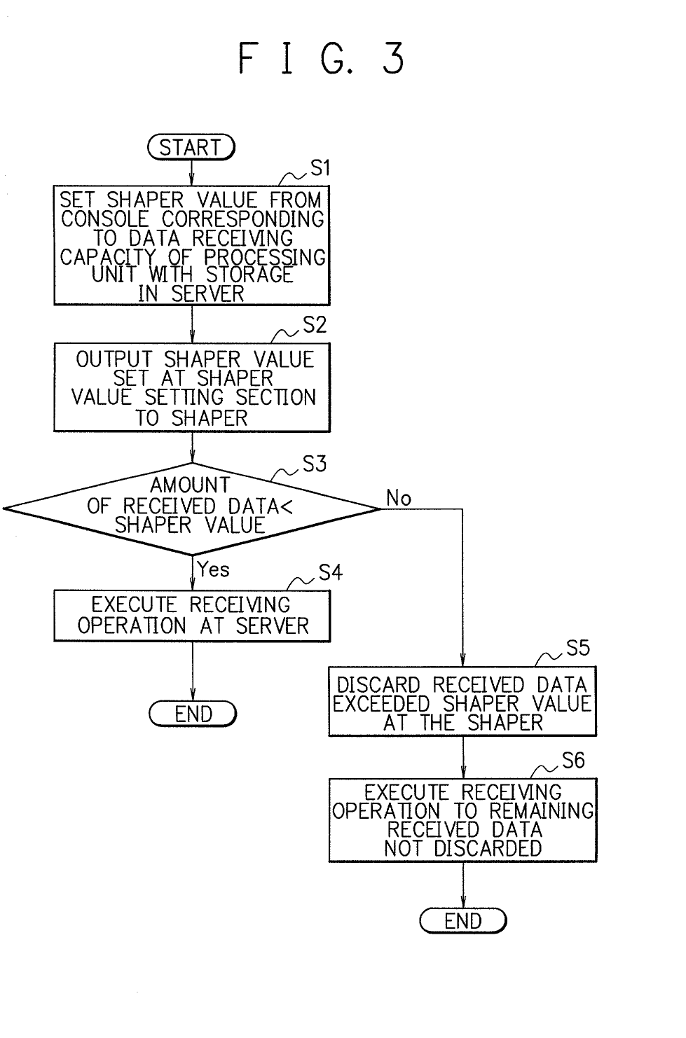

FIG. 3 is a flowchart showing received data control operation at the server 1 in the embodiment of the present invention. First, a shaper value is set in the shaper value setting section 12 through a console (not shown) provided at the outside, corresponding to a data receiving capacity of the processing unit with storage 13 in the server 1 (step S1). The shaper value set in the shaper value setting section 12 is outputted to the shaper 11 (step S2). At the shaper 11, the amount of received data (total received load) is compared with the shaper value (step S3). When the amount of the received data<the shaper value (Yes at the step S3), it is judged that the amount of the received data does not exceed the data receiving capacity at the server 1, and data receiving operation at the server 1 is executed (step S4).

When the amount of the received data≧the shaper value (No at the step S3), received data exceeded the shaper value are discarded at the shaper 11 (step S5). After this, data receiving operation at the server 1 is executed for remaining received data not discarded (step S6).

When the shaper 11 discards the received data, by utilizing an EPD (early packet discard) being an existing technology, the receiving efficiency can be increased.

Furthermore, when the shaper 11 discards the received data, by giving the order of priority to each of the received data (packet), and by executing the priority control in which a packet having a low priority is discarded, consequently, a QoS (quality of service) can be executed.

The embodiment mentioned above is a suitable example at the embodiment of the present invention. The embodiment can be used for various applications. For example, by monitoring processes in the processing unit with storage 13, the receiving capacity changing by its situation can be detected. With this, the received load control can be executed without any operation of a user, by setting the shaper value based on the detected value.

As mentioned above, according to the present invention, at the input port of the server 1, the received load (received data) can be controlled corresponding to the receiving capacity of the processing unit with storage 13. Therefore, deteriorating remarkably the performance of the server 1 itself and stopping the functions of the server 1 can be prevented, and the bad influence to the network 3 can be decreased.

And by utilizing the EPD, the receiving efficiency can be improved.

Furthermore, according to the present invention, by utilizing the priority control for discarding the received packets, the QoS can be increased.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A server, comprising:
a comparing means for comparing the amount of received load caused by received data transferred from plural clients with a designated value; and
a judging means for judging whether a part of said received data is discarded or not, wherein:
said server controls said received load caused by said received data transferred from said plural clients by said judged result.

2. A server in accordance with claim 1, wherein:
said designated value is set based on a receiving capacity of said server.

3. A server, comprising:
a shaper value setting means for setting a shaper value based on a receiving capacity of said server; and
a shaper means for comparing the amount of received load caused by received data transferred from plural clients and said shaper value, and judging whether a part of said received data transferred from said plural clients is discarded or not.

4. A server in accordance with claim 3, wherein:
said shaper means discards a part of said received data being exceeded said received load by said judged result.

5. A server in accordance with claim 4, wherein:
in case that said shaper judges that the amount of said received load exceeds said shaper value and discards a part of said received data, when a part of said received data (packet) is discarded by utilizing an EPD (early packet discard), a remaining part of said packet is discarded early.

6. A server in accordance with claim 4, wherein:
in case that said shaper judges that the amount of said received load exceeds said shaper value and discards a part of said received data, a part of said received data (packet) is discarded from a packet having low priority by utilizing a QoS (quality of service) based on the order of priority to each of said received data (packet).

7. A network system, comprising
plural clients connecting to a network; and
a server connecting to said plural clients through said network, wherein:
said server controls the amount of received load caused by the received data transferred from said plural clients.

8. A network system in accordance with claim 7, wherein
said server compares the amount of said received load caused by said received data with a designated value and judges whether a part of said received data is discarded or not based on said judged result.

9. A network system in accordance with claim 8, wherein
said designated value is set by a receiving capacity of said server.

10. A network system, comprising
plural clients connecting to a network; and
a server connecting to said plural clients through said network, wherein: said server, comprising:
a shaper value setting means for setting a shaper value based on a receiving capacity of said server; and
a shaper means for comparing the amount of received load caused by received data transferred from plural clients and said shaper value, and judging whether a part of said received data transferred from said plural clients is discarded or not.

11. A network system in accordance with claim 10, wherein:
said shaper discards a part of said received data when the amount of said received load exceeds said shaper value.

12. A network system in accordance with claim 10, wherein:
in case that said shaper judges that the amount of said received load exceeds said shaper value and discards a part of said received data, when a part of said received data (packet) is discarded by utilizing an EPD, a remaining part of said packet is discarded early.

13. A network system in accordance with claim 10, wherein:
in case that said shaper judges that the amount of said received load exceeds said shaper value and discards a part of said received data, a part of said received data (packet) is discarded from a packet having low priority by utilizing a QoS based on the order of priority to each of said received data (packet).

14. A received load control method at a network system in which a server connects to plural clients through a network, wherein: said server comprising the steps of:
setting a shaper value based on a receiving capacity of said server;
comparing the amount of received load caused by received data transferred from said plural clients and said shaper value; and
discarding a part of said received data being exceeded said shaper value when the amount of said received load exceeds said shaper value.

15. A received load control method at a network system in which a server connects to plural clients through a network in accordance with claim 14, wherein: at said discarding a part of said receiving data,
in case that the amount of said received load exceeds said shaper value and a part of said received data is discarded, when a part of said received data (packet) is discarded by utilizing an EPD, a remaining part of said received data (packet) is discarded early.

16. A received load control method at a network system in which a server connects to plural clients through a network in accordance with claim 14, wherein: at said discarding a part of said receiving data,
in case that the amount of said received load exceeds said shaper value and a part of said received data is discarded, a part of said received data (packet) is discarded from a packet having low priority by utilizing a QoS based on the order of priority to each of said received data (packet).

17. A received load control method at a network system in which a server connects to plural clients through a network in accordance with claim 14, wherein: at said setting a shaper value,
said shaper value is set by equipment disposed at the outside.
